(19) United States
(12) Patent Application Publication
(10) Pub. No.: US 2016/0373548 A1
(43) Pub. Date: Dec. 22, 2016

(54) SYSTEM AND METHOD FOR ENHANCING THE USAGE OF A SOCIAL NETWORKING SITE

(71) Applicant: Karmen Fails, Philadelphia, PA (US)

(72) Inventor: Karmen Fails, Philadelphia, PA (US)

(21) Appl. No.: 14/745,445

(22) Filed: Jun. 21, 2015

(51) Int. Cl. H04L 29/08

(52) U.S. Cl. CPC H04L 67/306

(57) ABSTRACT

The present invention relates to a system and method for enhancing the usage of a social networking site by facilitating a privileged and restricted access to the content. The social networking site facilitates the privileged and restricted access to the content by registering the primary user(s) with the social networking site and by granting access tiers to the content based on which the authorized secondary user(s) can access the content. Further, the online edits tracked for the content associated with the primary user(s) is notified to the secondary user(s).

### FIELD OF THE INVENTION

The present invention generally relates to enhancing the usage of a social networking site and more particularly relates to enhancing the usage of the social networking site by facilitating a privileged and restricted access to the content associated with the user(s).

### BACKGROUND OF THE INVENTION

Usage of social networking sites has increased enormously as the sites provide a common platform for users to share information, create a personal profile, advertise products, cultivate relationships, and for many other networking related tasks or activities.

In real-time scenario, users may want to share relevant information with a set or group of users based on the type of association or the relationship the user has with other networking users. Further, users sharing the content on the social networking site may want to authorize other users who are interested in accessing the information relevant to the user(s). However, the existing social networking sites shares the information with all the users and do not support the concept of restricted content access by building and maintaining social relationship across the networking users at different levels. Further, the social networking sites do not mandate the users to register with the site based on the user's personal profile or based on the user's interest in sharing the relevant information with other users within the network. Since, information exists in the public domain any user can post the content and/or access the information without encountering any issues related to information privacy.

Hence, there is a need for enhancing the usage of social networking site by facilitating a privileged and restricted access to the content associated with the user.

### SUMMARY OF THE INVENTION

The present invention relates to a system and method for enhancing the usage of a social networking site by facilitating a privileged and restricted access to the content, wherein the method comprises of registering a primary user with the social networking site to create a personal profile and to share content of the primary user with the secondary user(s). Further, the method allows the primary user to tag one or more attributes with the personal profile created for the primary user to uniquely identify the personal profile and determines a pre-qualified relationship between the primary user and the secondary user(s) intending to access the content associated with the primary user. Further, the method grants access tiers to facilitate privileged and restricted access to the content associated with the primary user and defines access privilege for the secondary user(s) based on the pre-qualified relationship determined between the primary user and the secondary user(s). Further, the method approves a request received from the secondary user(s) to access the content associated with the primary user through the social networking site and shares the content associated with the primary user based on the access tier granted for the secondary user(s). Further, the method allows the primary user to customize the presentation of the personal profile while sharing the personal profile with the secondary user(s). Further, the method allows editing and terminating the access tier defined for the secondary user(s) to access the content associated with the primary user. Further, the method allows the secondary user(s) to search for the personal profile/content that is created for the primary user based on the attribute(s) tagged with the personal profile and notifies the secondary user(s) about the personal profile/content being edited by the primary user. Further, the method links the online communication social networking site with the social networking site to support online communication.

### BRIEF DESCRIPTION OF DRAWINGS

FIG. 1 illustrates a working overview of the system 100 used to implement the method for enhancing the usage of a social networking site 102 by facilitating a privileged and restricted access to the content within a network 101.

FIG. 2 illustrates a flow-chart 200 that explains the process of implementing the method for enhancing the usage of the social networking site 102.

FIG. 3 illustrates a screen-shot that depicts the access tiers granted to access the content associated with a primary user 103.

FIG. 4 illustrates a system overview of components 400 used to implement the method for enhancing the usage of the social networking site 102 within the network 101.

### FIGURE DESCRIPTION

100—A system overview
101—A network for implementing the method
102—A social networking site used for implementing the method
103—Primary user(s) who owns the content
104—Secondary user(s) connected to the primary user to access the content
105—An online communication networking site linked to the social networking site
400—A system overview of components used for implementing the method
401—A registration module
402—An access tier module
403—A storage module
404—A content sharing module
405—A notification module
406—A controlling module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, the term social networking site 102 refers to a networking site through which information or content along with the personal profile associated with the primary user(s) 103 can be shared with the secondary user(s) 104 within a network 101. However, the social networking site 102 does not support online communication such as instant messaging, sharing comments, likes, and/or dislikes.

In an embodiment, the term primary user(s) 103 can refer to a business unit, an organization, an individual user, or any other entity who registers with the social networking site 101 to share the content and/or personal profile associated with the user(s). Further, the primary user(s) 103 defines the access tier to access the content and/or personal profile of the user(s) and also authorizes the secondary user(s) 104 to access the content and/or personal profile associated with the primary user(s) 103.

In another embodiment, the primary user(s) 103 can access the secondary user(s) content and/or personal profile as the secondary user(s) 104 shares the content on the social networking site 102 and allows the primary user(s) 103 to access the content.

In an embodiment, the term secondary user(s) 104 refers to any other user(s) other than the primary user(s) 103 who is/are interested in accessing the content and/or personal profile of the primary user(s) 103 based on the access tier granted or defined by the primary user(s) and authorized by the primary user(s) 103.

In an embodiment, the term user(s) commonly refer to both the primary user(s) 103 as well as the secondary user(s) 104. Further, the user(s) must register with the social networking site 102 for sharing the content or the profile within the network 101 by providing the necessary information through the social networking site 102.

In an embodiment, the method of granting or defining the access tier to access the content and/or personal profile of the primary user(s) 103 comprises of determining the type of relationship or association that exists between the primary user(s) 103 and the secondary user(s) 104 based on which the level of information associated with primary user's 103 content and/or personal profile can be shared with the secondary user(s) 104.

In an embodiment, the user(s) can define a default access tier list or customize the access tier list to share relevant information with the specific group(s) of users within the network 101. Further, the group specified/defined access tier list can be shared or customized to provide relevant information to individual user(s) within the specific group.

In an embodiment, the terms information, content, and/or personal profile commonly refers to the data associated with the primary user(s) 103 that is shared on the social networking site, which can be accessed by the secondary user(s) 104 based on the access tier granted for the data and authorization provided by the primary user(s) 103.

In an embodiment, the term privileged and restricted access to the content and/or personal profile of the primary user(s) defines the level of information that can be shared with the authorized secondary user(s) within the network 101. For example, if the secondary user is determined to be a close friend of the primary user then most of the content associated with the primary user can be shared with the secondary user through the social networking site 102. However, if the secondary user 104 is determined to be an acquaintance for the primary user 103 then the primary user 103 will provide access to the basic content associated with the primary user 103 through the social networking site 102.

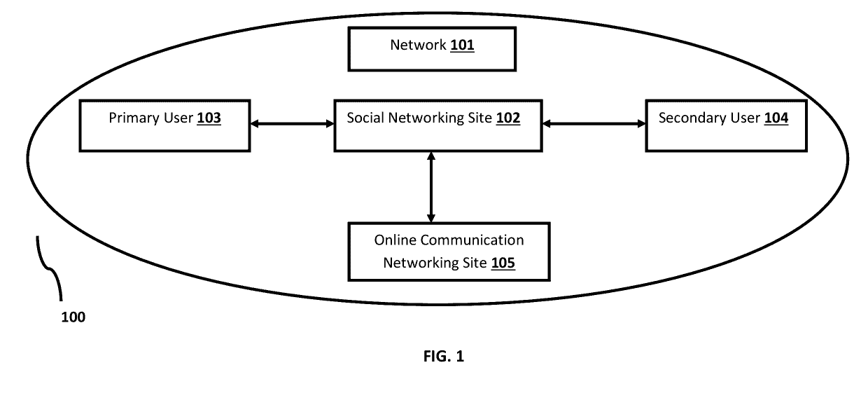

Referring to FIG. 1 illustrates a working overview of the system 100 used to implement the method for enhancing the usage of a social networking site 102 by facilitating a privileged and restricted access to the content within the network 101. In an embodiment, the primary user(s) 103 registers with the social networking site 102 by providing a primary user identifier and basic information such as email, phone number, age, areas of interest, address, and other details relevant to the primary user(s) 103. During registration, the primary user(s) 103 can choose to represent themselves on the social networking site 102 by configuring or selecting various attributes that contributes to the visual display of the user's profile or supports personalized representation of the user's profile. For example, the attributes that contributes to the visual display of the user's profile includes but not limited to background images, font style, font color, background texture, image or picture formats, or the like. Further, the registration of the primary user(s) 103 will be completed as the primary user(s) 103 responds to the questionnaire provided by the social networking site 102. In an embodiment, the questionnaire provided by the social networking site 102 comprises of various sections that can be optionally answered by the primary user(s) 103 based on the user's interest and personal factors such as age, which enables the primary user(s) 103 to respond with relevant information. Upon completing the questionnaire with relevant information, the primary user(s) 103 will be registered to the social networking site 102. The registered primary user(s) 103 can define or grant access tier for accessing the content and/or personal profile. In an embodiment, the secondary user(s) 104 needs to be authorized by the primary user(s) 103 for accessing the content and/or personal profile associated with the primary user 103. Further, based on the access tier granted for the primary user's 103 content, authorized secondary user(s) 104 can have the privilege of accessing different level of information through the social networking site 102. For example, if the secondary user 104 is the son/daughter of the primary user 103 then the access tier defined for the primary user's 103 content or information allows the secondary user 104 to access the property related information associated with the primary user 103.

In an embodiment, the method allows the secondary user(s) 104 to search for the primary user(s)'s 103 personal profile based on the attributes associated or tagged with the primary user's 103 personal profile. For example, if the primary user A's personal profile is associated with an attribute for liking pop music then the secondary user(s) can extract the primary user A's personal profile by providing a keyword such as “pop music” in the search option.

In an embodiment, the user(s) can access other user(s) profile based on the pre-qualified relationship/association established between the users through the social network site 102. Further, the social networking site 102 allows profile searching of only known or related user's within the network.

In an embodiment, the social networking site 102 allows the user(s) to edit the profile or change the access-tier list defined for the user profile/content in real-time. The edits made to the access-tier list is reflected as the secondary user(s) 104 view the content or profile defined as per the access-tier list. The edits made to the access-tier list comprises of changing the access level provided to the secondary user(s) 104, modifying the access level provided to the secondary user(s) 104, enhancing the access level provided to the secondary user(s) 104, terminating the access level provided to the secondary user(s) 104, or the like. Further, the social networking site 102 allows the user(s) to request for granting or denying the access level associated with the user's profile at a group level or at an individual level. For example, if the user A grants access to private profile information for group C then all the users categorized under group C can access the private profile information associated with user A. Further, the social networking site 102 can provide an option to automatically notify the access privilege updates to all the users categorized under the group.

In an embodiment, the social networking site 102 allows the user(s) to view the content or profile based on the criteria defined using one or more attributes associated with the user(s) profile. For example, if the primary user 103 wants to share the content with individuals who are above the age group of 18 years, then the social networking site 102 allows the primary user to define the access-level based on this criterion. As the primary user 103 defines the access-level of the content for secondary user(s) 104 above 18 years, secondary user(s) 104 who meet this criterion can view the shared content through the social networking site 102.

In an embodiment, the social networking site 102 allows the user(s) to search for the content within a user profile or across the content shared from one or more associated user(s) within the network 101.

In an embodiment, an online communication networking site 105 is configured to link with the social networking site 102 to support online communication with third party social networking sites 102. For example, the online communication networking site 105 linked to the social networking site 102 includes but not limited to an Instagram, a Face book, a Twitter, an Instant message, or the like. The primary user(s) 103 can establish a pre-qualified relationship with the secondary user(s) 104 after linking with the third party social networking site(s) 102, and/or through the third party social networking site 102 linking, the user(s) can view the website of the related/associated user(s). Further, the social networking site 102 allows the user(s) to view the favorite sites/wish list sites of the associated user(s). For example, the favorite sites/wish list sites of the user(s) that can be shared with the associated user(s) through the social networking site 102 includes sites such as Amazon, ebay, or the like.

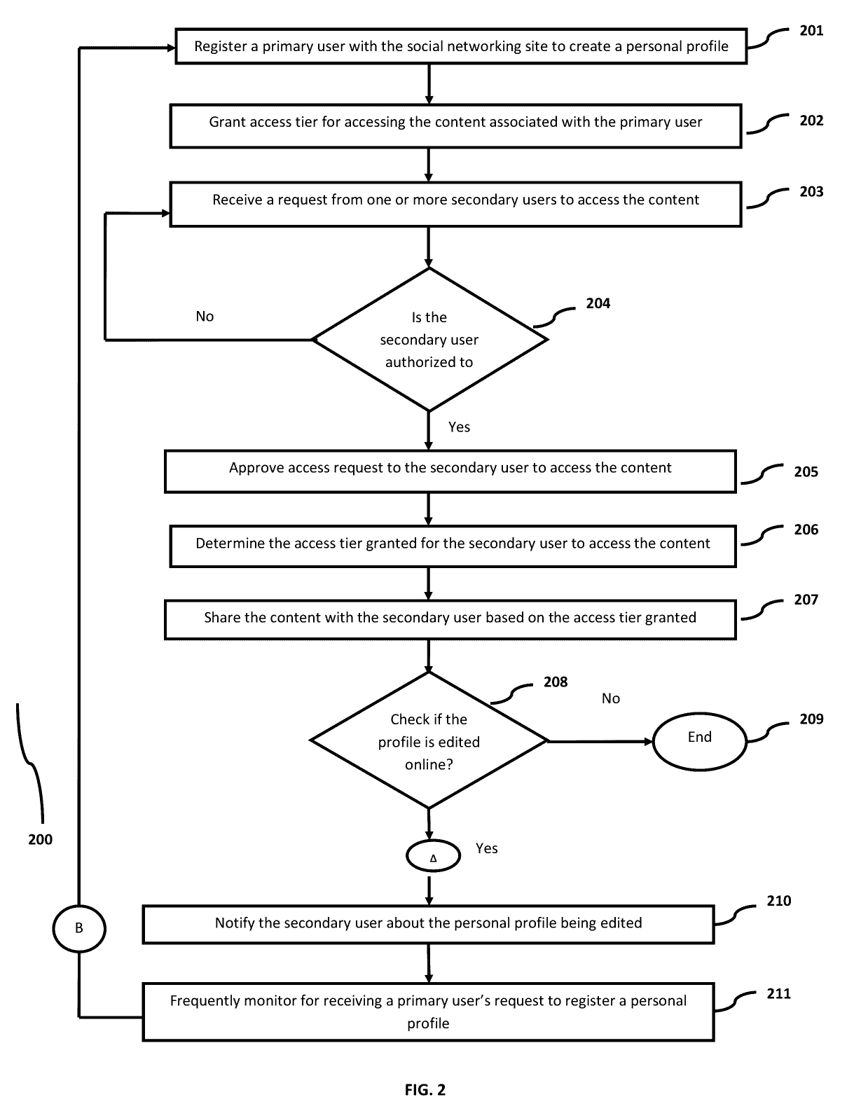

Referring to FIG. 2 illustrates a flow-chart 200 that explains the process of implementing the method for enhancing the usage of the social networking site 102. Initially, at step 201, the method 200 allows the primary user(s) 103 to register with the social networking site 102 by creating a personal profile. While registering the primary user(s) 103, the social networking site 102 provides a questionnaire to the primary user(s) 103 that has to be responded and submitted for completing the primary user(s) 103 registration. At step 202, the method 200 allows the primary user(s) 103 to grant or define the access tier for accessing the content associated with the primary user(s) 103. For example, the access tier can define that if the secondary user(s) 104 is acquainted with the primary user(s) 103, then as example the primary user(s) 103 may be willing to share his/her availability status, preferred location to meet, fashion related information with the secondary user(s) 104. Accordingly, the method 200 allows the primary user(s) 103 to define or grant access tier for the content shared on the social networking site 102 for the secondary user(s) 104 associated with the primary user(s) 103 in different ways. At step 203, the method 200 is configured to receive the access request initiated by the secondary user(s) 104. At step 204, the method 200 is configured to determine if the secondary user(s) initiating an access request is authorized to access the content associated with the primary user(s) 103. If the method 200 determines that the secondary user(s) 104 access request is authorized by the primary user(s) 103 then at step 205, the method 200 allows the primary user(s) 103 to approve the request. However, if the method 200 determines that the secondary user(s)'s 104 access request is not authorized by the primary user(s) 103 then the method 200 notifies the secondary user(s) about declining the access request. Further, the method 200 continues to receive additional access request from other secondary user(s). If the method 200 determines that the secondary user(s) 104 access request is authorized by the primary user(s) 103 then at step 206, the method 200 determines the access tier granted for the content to be accessed by the secondary user(s) 104. Based on the access tier granted for the content, at step 207, the method 200 shares relevant information or content with the secondary user(s) 104 through the social networking site 102. As the secondary user(s) 104 is accessing the content through the social networking site 102, at step 208, the method 200 checks if the content associated with the primary user(s) is edited online. If the method 200 determines that the content is being edited by the primary user(s) 103 in the social networking site 102, then at step 210 the method 200 is configured to notify the secondary user(s) 104 viewing the content about the online edits. However, if the method 200 determines that there is no online content edition, then at step 209 the process ends. Further, at step 211, the method 200 is configured to monitor for additional registration requests sent by the primary user(s) 103.

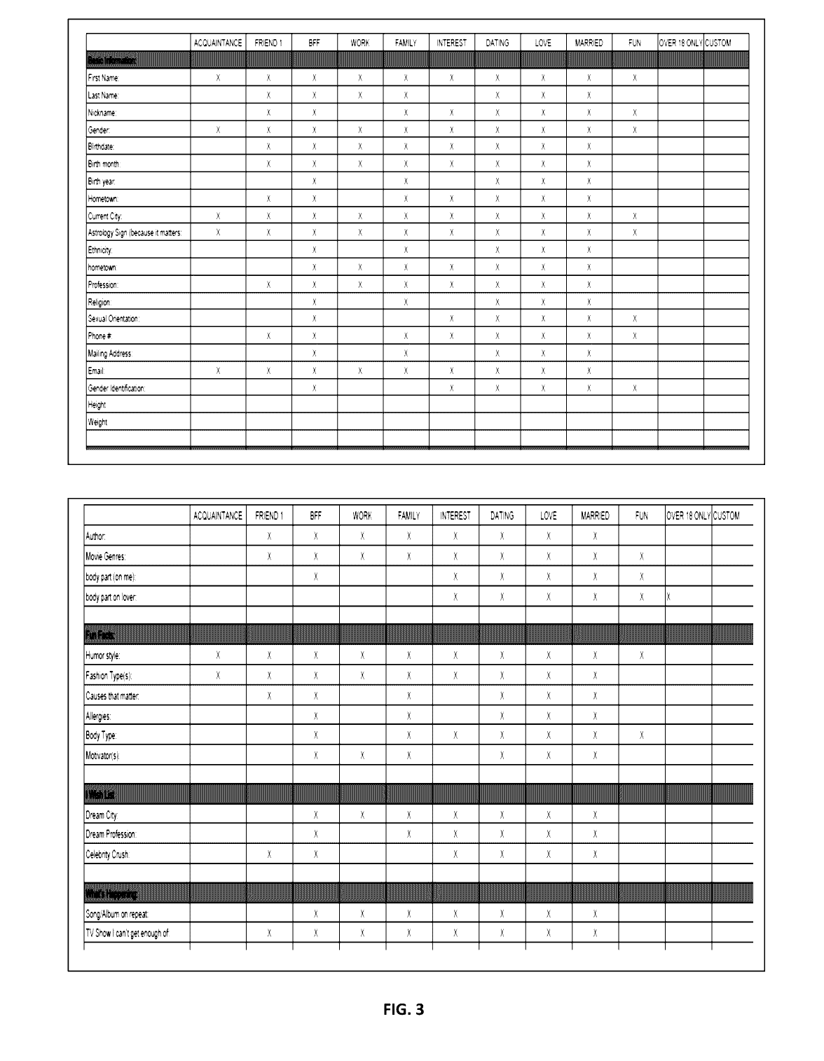

Referring to FIG. 3 illustrates a screen-shot that depicts the access tiers granted to access the content associated with the primary user 103. The access tiers granted to access the content associated with the primary user(s) 103 is depicted as a 2-dimensional array wherein the X co-ordinates capture different level of association the secondary user(s) 104 has established with the primary user(s) 103 and Y co-ordinates capture information type that can be granted to the secondary user(s) 104 associated with the primary user(s) 103 at different levels. For example, X co-ordinates capture the level of association of the secondary user(s) 104 as an acquaintance, a friend, a best friend, a family member, an interest member, a dating partner, a loved person, a spouse, or a romantic fling with the primary user(s) 103. Further, the Y co-ordinates capture information such as personal profile, Fun facts, wish list, or the like that is associated with the primary user(s) 103. Further, the field marked with an “x” symbol in the 2D matrix denotes that the secondary user(s) 104 considered to be associated with the primary user 103 (corresponding to X-axis) is granted to access the information corresponding to the Y axis.

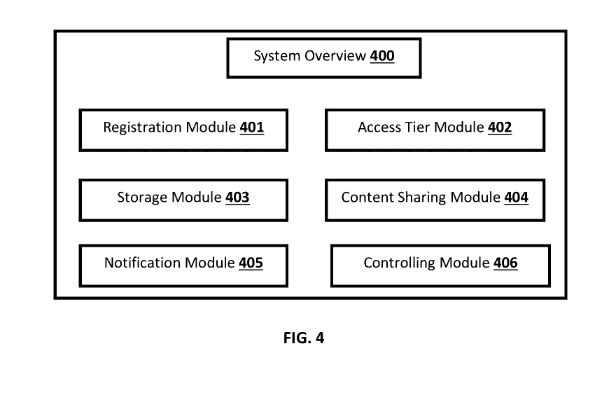

Referring to FIG. 4 illustrates a system overview 400 of components used to implement the method for enhancing the usage of the social networking site 102, wherein the system comprises of the following components: a Registration module 401, an Access tier module 402, a Storage module 403, a Content sharing module 404, a Notification module 405, and a Controlling module 406. In an embodiment, the Registration module 401 is configured to register the primary user(s) 103 with the social networking site 102 for sharing the content with the secondary user(s) 104. The registration module 401 is configured to accept the personal profile of the primary user 103 along with a questionnaire that is filled with relevant response by the primary user 103 to complete the registration process. In an embodiment, the Access tier module 402 is configured to grant access tiers to the content associated with the primary user(s) 103. Based on the granted access tiers, authorized secondary user(s) 104 will be able to access different level of information associated with the primary user(s) 103. In an embodiment, the storage module 403 is configured to store the granted access tiers to the content associated with the primary user(s) 103. Further, the storage module 403 is configured to store the authorization related details to authorize the secondary user(s) for accessing the information associated with the primary user(s) 103. In an embodiment, the Content sharing module 404 is configured to share the content on the social networking site 102 with the authorized secondary user(s) 104 based on the access tier granted for the content associated with the primary user(s) 103. In an embodiment, the Notification module 405 is configured to notify the secondary user(s) 104 about the online edits tracked for the content associated with the primary user(s) 103. The notification module 405 can notify the secondary user(s) 104 about the online edits by sending alerts to the secondary user(s) 104 or by updating the secondary user(s) 104 through the configuration settings opted in the social networking site 102. In an embodiment, the controlling module 406 is configured to transfer data across various modules used to implement the method.

1. A method for enhancing the usage of a social networking site by facilitating a privileged and restricted access to the content, wherein said method comprises of:
registering a primary user with said social networking site to create a personal profile for said primary user;
tagging at least one attribute with said personal profile created for said primary user;
determining a pre-qualified relationship between said primary user and at least one secondary user optionally associated with said at least one group, intending to access the content associated with said primary user;
granting access tiers to provide privileged and restricted access to the content associated with said primary user based on said pre-qualified relationship determined between said primary user and said at least one secondary user, optionally associated with said at least one group;
providing access privilege to said at least one secondary user, optionally associated with said at least one group, based on said access tiers granted for the content associated with said primary user;
approving a request received from said at least one secondary user, optionally associated with said at least one group, to access the content associated with said primary user through said social networking site based on the access privilege granted to said at least one secondary user optionally associated with said at least one group;
sharing the content associated with said primary user based on the access tier granted for said at least one secondary user, optionally associated with said at least one group;
allowing said primary user to customize the presentation of said personal profile while sharing said personal profile with said at least one secondary user, optionally associated with said at least one group;
terminating the access tier granted for said at least one secondary user, optionally associated with said at least one group, to access the content associated with said primary user;
allowing said primary user to edit said personal profile online that is created for said primary user;
allowing said at least one secondary user, optionally associated with said at least one group, to search for said personal profile that is created for said primary user based on said at least one attribute tagged with said personal profile;
notifying said at least one secondary user, optionally associated with said at least one group, about said personal profile being edited by said primary user; and
linking of at least one online communication social networking site with said social networking site to support online communication.

2. The method as claimed in claim 1, wherein registering said primary user with said social networking site comprises of generating a unique identifier for said primary user and associating said unique identifier along with said primary user's personal information such as an email id, a phone number, or the like.

3. The method as claimed in claim 1, wherein said access tiers granted for accessing the content associated with said primary user determines the level of information to disclose to said at least secondary user through said social networking site.

4. The method as claimed in claim 3, wherein said access tiers granted for accessing the content associated with said primary user is determined based on the type of relationship established between said at least one secondary user and said primary user.

5. The method as claimed in claim 1, wherein editing said personal profile online that is created for said primary user comprises of updating, modifying, or removing at least one segment of said personal profile from said social networking site.

6. The method as claimed in claim 1, wherein notifying said at least one secondary user about said personal profile being edited by said primary user comprises of sending notification through an alert, through a configuration setting opted by said primary user.

7. The method as claimed in claim 1, wherein linking of said at least one online communication social networking site includes but not limited to a face book, an Instagram, an Amazon site, a Twitter.

8. A system for enhancing the usage of a social networking site by facilitating a privileged and restricted access to the content, wherein said system comprises of said social networking site and is configured to:
register a primary user with said social networking site to create a personal profile for said primary user;
tag at least one attribute with said personal profile created for said primary user;
determine a pre-qualified relationship between said primary user and at least one secondary user, optionally associated with said at least one group, intending to access the content associated with said primary user;
grant access tiers to provide privileged and restricted access to the content associated with said primary user based on said pre-qualified relationship determined between said primary user and said at least one secondary user, optionally associated with said at least one group;
provide access privilege to said at least one secondary user, optionally associated with said at least one group, based on said access tiers granted to access said personal profile that is created for said primary user;
approve a request received from said at least one secondary user, optionally associated with said at least one group, to access the content associated with said primary user through said social networking site based on the access privilege granted to said at least one secondary user, optionally associated with said at least one group;
share the content associated with said primary user based on the access tier granted for said at least one secondary user optionally associated with said at least one group;
allow said primary user to customize the presentation of said personal profile while sharing said personal profile with said at least one secondary user optionally associated with said at least one group;
terminate the access tier granted for said at least one secondary user, optionally associated with said at least one group, to access the content associated with said primary user;
allow said primary user to edit said personal profile online that is created for said primary user;
allow said at least one secondary user, optionally associated with said at least one group, to search for said personal profile that is created for said primary user based on said at least one attribute tagged with said personal profile;
notify said at least one secondary user, optionally associated with said at least one group, about said personal profile being edited by said primary user; and
allow linking of at least one online communication social networking site with said social networking site to support online communication.

9. The system as claimed in claim 8, wherein registering said primary user with said social networking site comprises of generating a unique identifier for said primary user and associating said unique identifier along with said primary user's personal information such as an email id, a phone number, or the like.

10. The system as claimed in claim 8, wherein said access tiers granted for accessing the content associated with said primary user determines the level of information to disclose to said at least secondary user through said social networking site.

11. The system as claimed in claim 10, wherein said access tiers granted for accessing the content associated with said primary user is determined based on the type of relationship established between said at least one secondary user and said primary user.

12. The system as claimed in claim 8, wherein editing said personal profile online that is created for said primary user comprises of updating, modifying, or removing at least one segment of said personal profile from said social networking site.

13. The system as claimed in claim 8, wherein notifying said at least one secondary user about said personal profile being edited by said primary user comprises of sending notification through an alert, through a configuration setting opted by said primary user.

14. The system as claimed in claim 1, wherein linking of said at least one online communication social networking site includes but not limited to a Face book, an Instagram, an Amazon site, a Twitter.

15. A computer program product comprising computer executable program code recorded on a computer readable non-transitory storage medium, said computer executable program code when executed, causing the actions including:
registering a primary user with said social networking site to create a personal profile for said primary user;
tagging at least one attribute with said personal profile created for said primary user;
determining a pre-qualified relationship between said primary user and at least one secondary user, optionally associated with said at least one group, intending to access the content associated with said primary user;
granting access tiers to provide privileged and restricted access to the content associated with said primary user based on said pre-qualified relationship determined between said primary user and said at least one secondary user, optionally associated with said at least one group;
providing access privilege to said at least one secondary user, optionally associated with said at least one group, based on said access tiers granted for the content associated with said primary user;
approving a request received from said at least one secondary user, optionally associated with said at least one group, to access the content associated with said primary user through said social networking site based on the access privilege granted to said at least one secondary user;
sharing the content associated with said primary user based on the access tier granted for said at least one secondary user optionally associated with said at least one group;
allowing said primary user to customize the presentation of said personal profile while sharing said personal profile with said at least one secondary user, optionally associated with said at least one group;
terminating the access tier granted for said at least one secondary user, optionally associated with said at least one group, to access the content associated with said primary user;
allowing said primary user to edit said personal profile online that is created for said primary user;
allowing said at least one secondary user, optionally associated with said at least one group, to search for said personal profile that is created for said primary user based on said at least one attribute tagged with said personal profile;
notifying said at least one secondary user, optionally associated with said at least one group, about said personal profile being edited by said primary user; and
linking of at least one online communication social networking site with said social networking site to support online communication.

16. The computer program product as claimed in claim 15, wherein registering said primary user with said social networking site comprises of generating a unique identifier for said primary user and associating said unique identifier along with said primary user's personal information such as an email id, a phone number, or the like.

17. The computer program product as claimed in claim 15, wherein said access tiers granted for accessing the content associated with said primary user determines the level of information to disclose to said at least secondary user through said social networking site.

18. The computer program product as claimed in claim 17, wherein said access tiers granted for accessing the content associated with said primary user is determined based on the type of relationship established between said at least one secondary user and said primary user.

19. The computer program product as claimed in claim 15, wherein editing said personal profile online that is created for said primary user comprises of updating, modifying, or removing at least one segment of said personal profile from said social networking site.

20. The computer program product as claimed in claim 15, wherein notifying said at least one secondary user about said personal profile being edited by said primary user comprises of sending notification through an alert, through a configuration setting opted by said primary user.
